(19) United States
(12) Patent Application Publication
(10) Pub. No.: US 2024/0051180 A1
(43) Pub. Date: Feb. 15, 2024

(54) BELLPACKER VIBRATION ASSEMBLY

(71) Applicant: BESSER COMPANY, Alpena, MI (US)

(72) Inventor: Byron Mark Hilts, Sioux City, IA (US)

(21) Appl. No.: 17/803,182

(22) Filed: May 20, 2022

Related U.S. Application Data
(60) Provisional application No. 63/191,021, filed on May 20, 2021.

(51) Int. Cl. B28B 1/087; E04G 21/06; B28B 21/16; F16F 15/02

(52) U.S. Cl. CPC B28B 1/0873; E04G 21/063; B28B 21/16; F16F 15/02

(57) ABSTRACT

A vibration assembly for supporting a base pallet of a concrete pipe manufacturing machine, and a method for adjusting the assembly. The assembly includes an assembly frame, at least two pallet driving blocks supported for position adjustment relative to one another on the frame, and a vibrator connected to at least one of the pallet driving blocks. The pallet driving blocks transmit force to the base pallet of the concrete pipe manufacturing machine.

### CROSS-REFERENCES TO RELATED APPLICATIONS

This application claims the benefit of the filing date of U.S. Provisional Patent Application Ser. No. 63/191,021, filed May 20, 2021, which is incorporated herein by reference in its entirety.

### BACKGROUND

### Field

This application relates generally to concrete pipe manufacturing.

### DESCRIPTION OF RELATED ART INCLUDING INFORMATION DISCLOSED UNDER 37 CFR 1.97 AND 1.98 U.S. Pat. No. 7,896,517

Modular concrete pipe manufacturing processes benefit from packing and troweling of concrete introduced into a mold during the production process. Bell packers are devices used to provide this compacting and troweling on various flared or generally bell-shaped portions of concrete pipes and pipe fittings. Bell packers require a library of turning and vibrating adapters having various sizes and shapes configured to connect the bell packer to—and transmit motion to—the variously-sized and shaped pallets used to support and pack the flared base of the pipes and other pipe components during production.

### SUMMARY

A vibration assembly for supporting different sizes and types of concrete pipe manufacturing machine base pallets is provided, the vibration assembly comprising an assembly frame and at least two pallet driving blocks supported for position adjustment relative to one another on the frame. The pallet driving blocks are configured to transmit force to a concrete pipe manufacturing machine base pallet. A vibrator is connected to at least one of the pallet driving blocks.

Also provided is a method of adjusting such a bell packer assembly. The method includes providing a recipe comprising predetermined driving block positions, to a controller of the bell packer assembly, each recipe of driving block positions being suitable for driving block engagement with a different respective type or size of pallet. The controller is actuated to command the motor to move the driving blocks to positions corresponding to the predetermined driving block positions of the recipe.

Another method provided for adjusting a bell packer assembly includes providing a recipe comprising predetermined driving block positions, to a controller of a bell packer assembly, the driving block positions being suitable for driving block engagement with a base pallet of a concrete product of a desired size. The controller is actuated to command the motor to move the driving blocks to respective positions corresponding to the respective predetermined driving block positions of the recipe.

### DRAWING DESCRIPTIONS

FIG. 1 is a perspective view of a bell packer assembly;

FIG. 2 is a top view of the assembly of FIG. 1;

FIG. 3 is a bottom view of the assembly of FIG. 1;

FIG. 4 is a top perspective view showing a different side of the assembly of FIG. 1;

FIG. 5 is a bottom perspective view of the assembly of FIG. 1;

FIG. 6A is a partial exploded view of the smaller and internal components of the assembly of FIG. 1;

FIG. 6B is a partial exploded view showing the external frame and cover components in positions generally corresponding to the positions of the components shown in FIG. 6;

FIG. 7 is a partial cutaway side view of a prior art bell packer shown installed for use in a concrete pipe production machine;

FIG. 8 is a cutaway side view showing molding components for a flared concrete pipe end as they would be arranged within the production machine of FIG. 8, as well as one of several typical pallet types upon which a concrete pipe is supported during production; and

FIG. 9 is a schematic view of the connections between electronic components related to the assembly.

### DETAILED DESCRIPTION

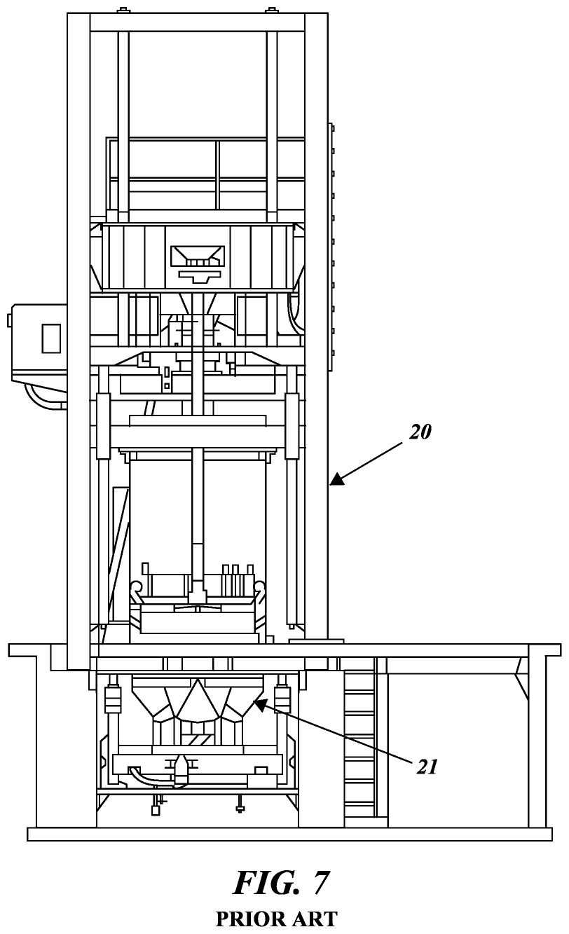

A vibration assembly for supporting a base pallet of a concrete pipe manufacturing machine is generally shown at 10 in the Figures. The vibration assembly 10 comprises a vibration assembly frame 12, at least two pallet driving blocks 14 supported for position adjustment relative to one another on the frame 12, and a vibrator 16 connected to at least one of the pallet driving blocks 14. The pallet driving blocks 14 transmit force to a pallet 18 (such as a base pallet) of a concrete pipe manufacturing machine such as, for example, the machine shown at 20 in FIG. 7.

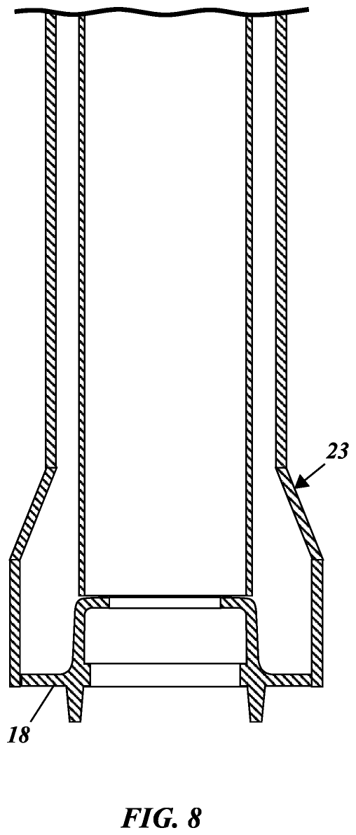

For comparison, a prior art bell packer assembly 21 is shown installed in the machine 20 shown in FIG. 7. The assembly 10 described here is configured to take the place of a prior art bell packer such as this, in machines such as the one shown at 20. In practice, the pallet 18 and mold 23 shown in FIG. 8 would be installed in the machine 20, with the pallet 18 resting atop a bell packer assembly 10 or 21.

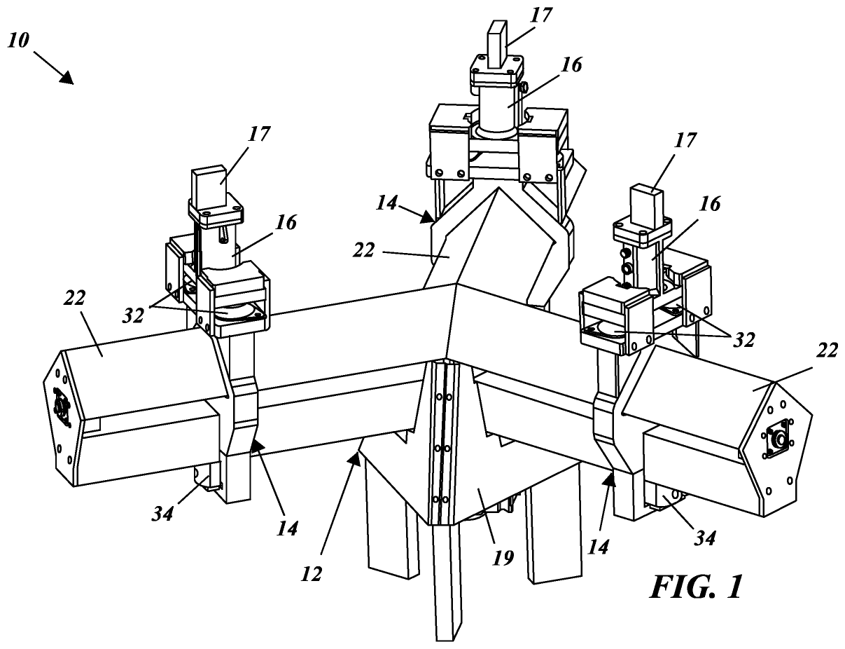

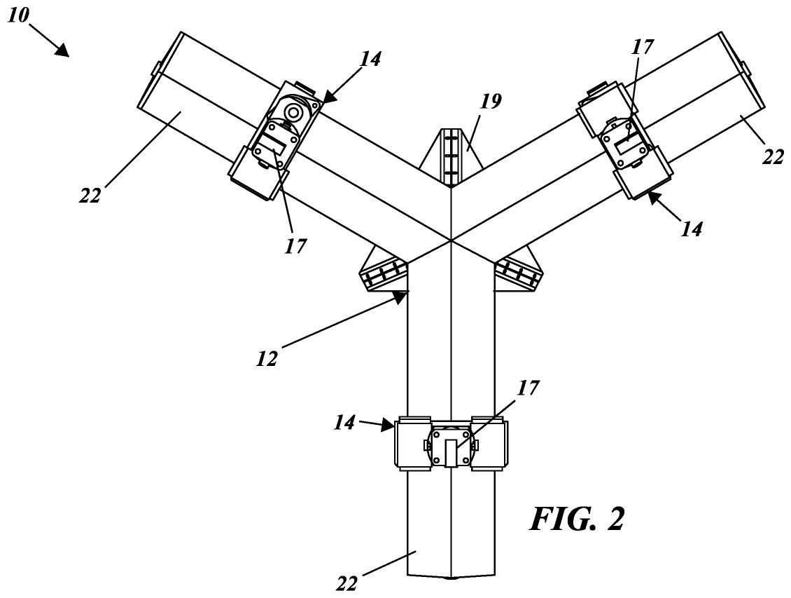

The vibration assembly frame 12 may comprise several rails 22. As shown in FIGS. 1-5, the assembly frame 12 may preferably comprise a central housing 19 and three rails 22 extending radially outward from the housing 19. One or more of the rails 22 may be configured to support a pallet driving block 14 for sliding motion along the rail 22. Preferably, each rail 22 may support a pallet driving block 14 for sliding movement along the rail 22. However, in other embodiments, the assembly 10 may comprise any one or more of a number of suitable rails 22 and driving blocks 14, and only some of the rails 22 need to support their respective pallet driving blocks 14 for sliding movement. The relative positioning of the pallet driving blocks 14 may therefore be adjusted to allow the blocks 14 to receive pallets, such as the one shown at 18 in FIG. 8, of different sizes and configurations as required to produce pipes and other parts of differing shapes and diameters.

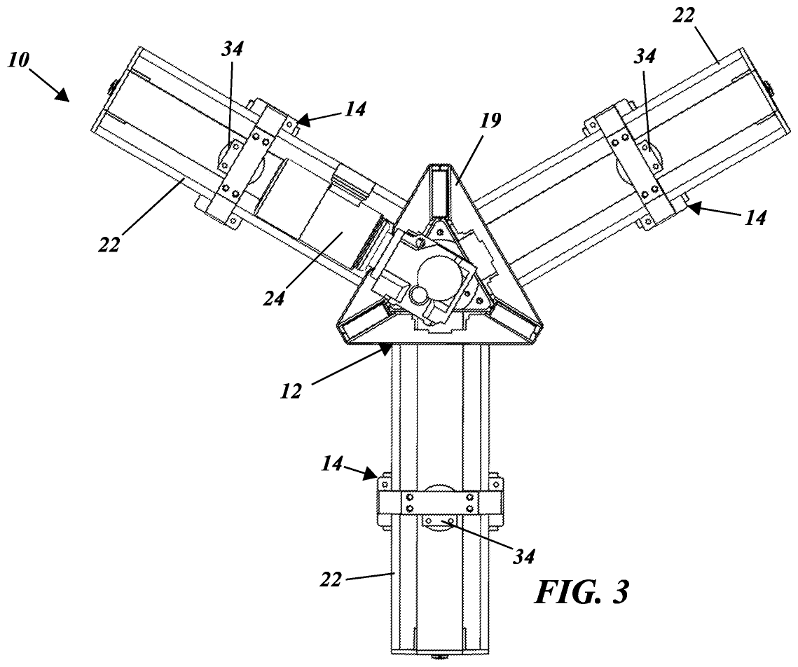

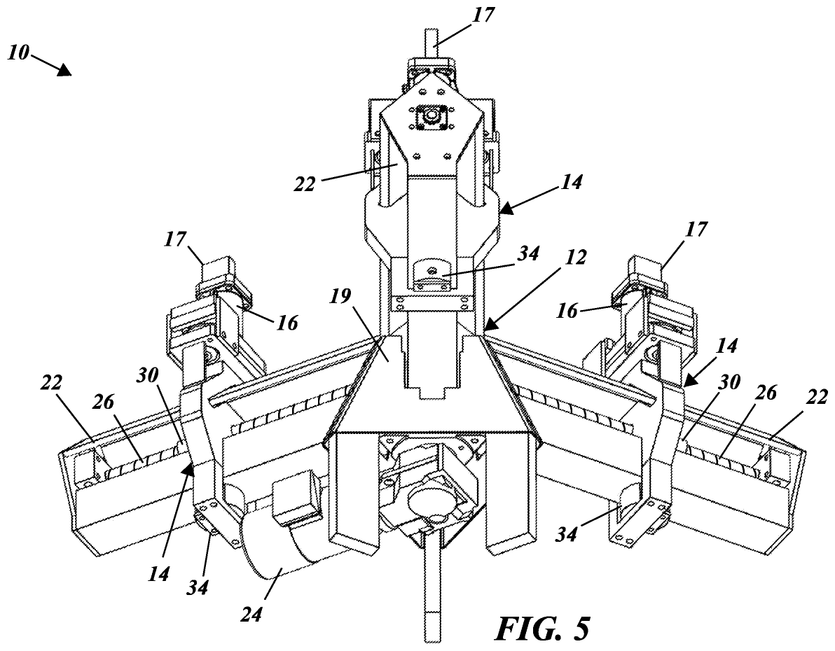

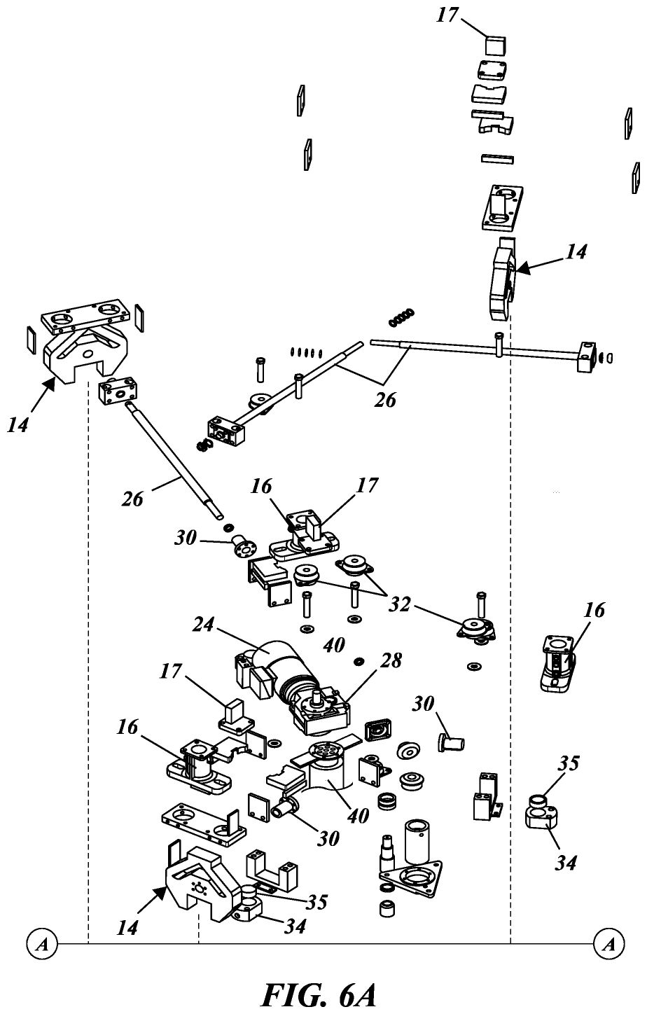

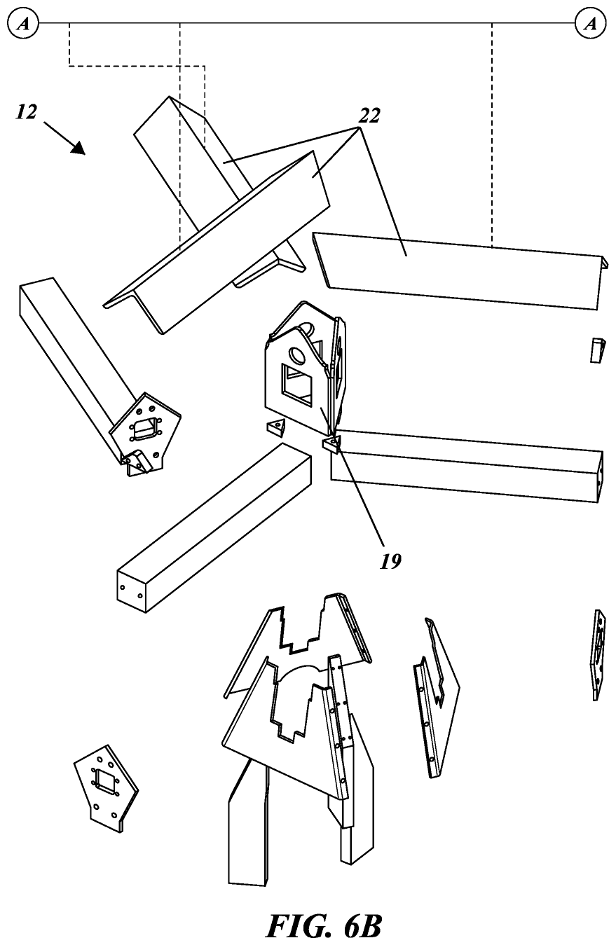

The driving blocks 14 may be moved along their respective supporting rails 22 by a driving block adjustment motor such as the electric gearmotor shown at 24 in FIGS. 3-6A. As best shown in FIGS. 5 and 6A, the adjustment motor 24 may be carried by the frame 12 and linked to ball screws 26 running along each rail 22 via a miter gear set 28. The gear set 28 may be carried in the frame's central housing 19, with the motor 24 mounted below the gearset so that the length of the motor 24 runs parallel to one of the rails 22. Each ball screw 26 may be linked to one of the pallet driving blocks 14 via a traveling nut 30 carried by each pallet driving block 14. The motor 24 may move all the driving blocks 14 simultaneously.

To supply vibration to the pallet 18, each pallet driving block 14 may carry one or more vibrators 16. These vibrators 16 may each comprise, for example, a pneumatic bin vibrator. Two of these vibrators 16 may be carried by each pallet driving block 14 in a position just below a pallet engagement interface 17 of the pallet driving block 14. Thanks to this positioning, the vibrators 16 can efficiently provide vibration to the pallet 18 by minimizing material through which the vibrations must travel to reach the pallet 18.

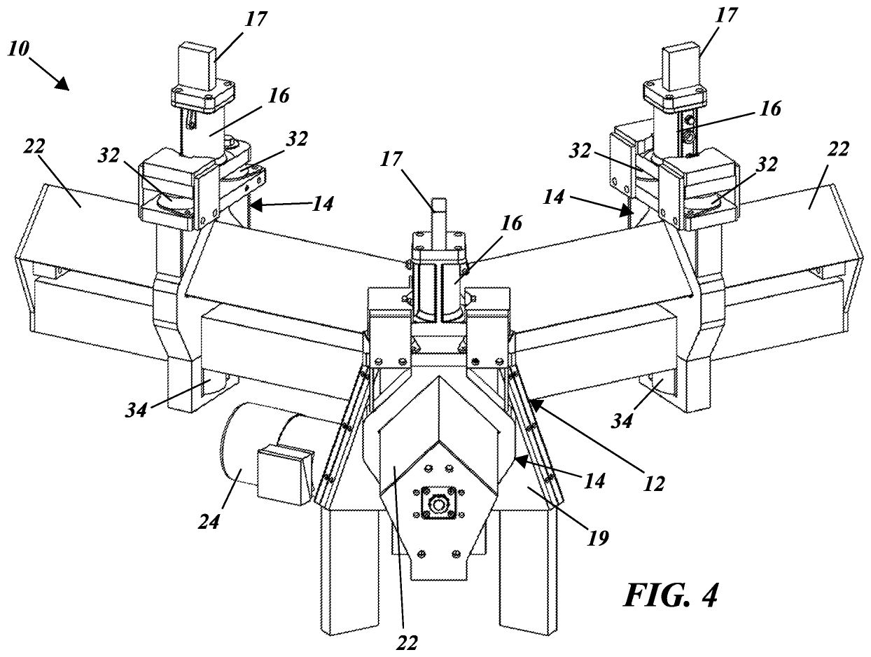

The driving blocks 14 may each also carry one or more vibration isolators 32 positioned to mitigate vibration transmitted to the frame 12. As best shown in FIGS. 1 and 4, each vibration isolator 32 may be mounted in a position connecting its respective driving block 14 to its respective vibrator, so that vibrations must travel through the isolator 32 to reach its respective driving block 14. The isolators 32 may comprise a resilient material suitable to absorb shocks, thereby reducing wear to the frame 12, and any equipment carried by the frame 12 that could be damaged by vibration.

As shown in FIGS. 4-6A, each driving block 14 may also carry a locking element 34 operatively connected to a hydraulic cylinder 35 positioned to cause the locking element 34 to engage and prevent relative motion between the frame 12 and at least one pallet driving block 14. This engagement may be provided, for example, by actuating the cylinder 35 to cause the locking element 34 to apply pressure to a surface 23 of the rail 22, creating friction.

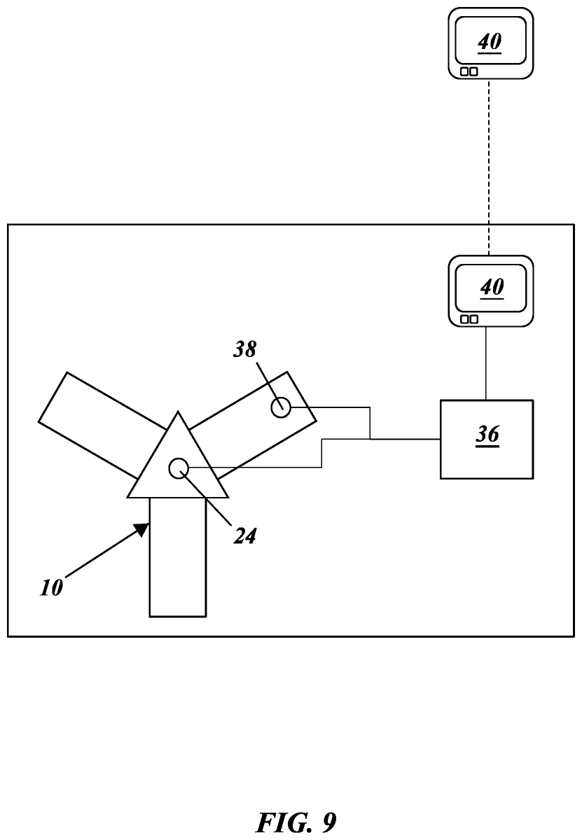

As shown in the schematic of FIG. 9, the assembly 10 may include a controller 36 configured to receive signals from sensors 38 and local or remote user interfaces 40, and, in response, to issue corresponding command or informative signals to components of the assembly 10, and to the user interfaces 40. The sensors 38 may include drive block position tracking sensors, such as encoders configured to determine the position of the drive blocks 14. Data representing predetermined drive block positions may be provided to the controller 36 along with a set of recipes sent to the concrete pipe manufacturing machine 20 and corresponding to respective desired pipe diameters. Each such recipe for a pipe of a desired diameter includes instructions to command the controller 36 to set the positions of the drive blocks 14 to receive a base pallet 18 corresponding to the diameter of the pipe that the recipe commands are intended to form. The controller 36 may then command the motors 24 to move the drive blocks 14 until the sensors 38 indicate that the drive blocks 14 are in a position that corresponds to a position prescribed by a selected recipe.

A combination rotary union and/or collector ring 40, shown in FIG. 6A, may be connected to supply power and grease to various parts of the assembly 10, e.g., to the vibrators 16, motor 24, and contact points of the pallet drive blocks 14.

A vibration assembly constructed as described above may be rotatably supported on a bell packer of a concrete pipe manufacturing machine. And the pallet driving blocks may be adjusted to match the diameters of pallet feet of various diameters of base pallets used by the pipe manufacturing machine. The varying pallets may be attached to the vibration assembly, which may apply vibration and turning force to the pallets, providing a packing and troweling effect on concrete as it is formed into a desired pipe shape.

This description, rather than describing limitations of an invention, only illustrates embodiments of the invention recited in the claims. The language of this description is therefore exclusively descriptive and is non-limiting. Obviously, it's possible to modify this invention from what the description teaches. Within the scope of the claims, one may practice the invention other than as described above.

What is claimed is:

1. A vibration assembly for supporting a base pallet of a concrete pipe manufacturing machine, the vibration assembly comprising:
an assembly frame;
at least two pallet driving blocks supported for position adjustment relative to one another on the frame, the pallet driving blocks being configured to transmit force to the base pallet of the concrete pipe manufacturing machine; and
a vibrator connected to at least one of the pallet driving blocks.

2. The vibration assembly of claim 1 in which the assembly frame comprises rails, each of the rails being configured to support a pallet driving block for sliding motion along the rail.

3. The vibration assembly of claim 2 in which the frame comprises a central housing and three rails extending radially outward from the housing.

4. The vibration assembly of claim 1 in which the assembly comprises a driving block adjustment motor carried by the frame and linked to ball screws running along each rail, each ball screw being linked to one of the pallet driving blocks, the driving block adjustment motor being connected to propel the pallet driving blocks along the rails.

5. The vibration assembly of claim 3 in which the motor is connected to all of the ball screws via miter gears carried by the frame.

6. The vibration assembly of claim 1 in which two of the vibrators are carried by each pallet driving block.

7. The vibration assembly of claim 1 in which the at least one pallet driving block carries at least one vibration isolator positioned to mitigate vibration transmitted to the frame.

8. The vibration assembly of claim 7 in which each driving block carries a vibrator and a vibration isolator, and the vibration isolator connects its respective driving block to its respective vibrator.

9. The vibration assembly of claim 1 in which a locking element is positioned to engage the frame and at least one pallet driving block to prevent the engaged pallet driving block from moving relative to the frame.

10. The vibration assembly of claim 9 in which the locking element is driven by a hydraulic cylinder.

11. The vibration assembly of claim 9 in which the locking element is attached in engagement with the pallet driving block so that it can move with the driving block relative to the frame when unengaged from the frame.

12. A method of adjusting the bell packer assembly of claim 1, the method including the steps of:
providing a recipe comprising predetermined driving block positions, to a controller of the bell packer assembly, the predetermined driving block positions being suitable for driving block engagement with the concrete pipe manufacturing machine base pallet; and
actuating the controller to command the motor to move the driving blocks to positions corresponding to the predetermined driving block positions of the recipe.

13. The method of claim 12 in which the step of actuating the controller comprises actuating the controller by selecting the recipe on a user interface.

14. A method of adjusting a bell packer assembly, the method including the steps of:
providing a recipe comprising predetermined driving block positions to a controller of a bell packer assembly, the predetermined driving block positions being suitable for driving block engagement with a base pallet of a concrete product of a desired size; and
actuating the controller to command the motor to move the driving blocks to respective positions corresponding to the respective predetermined drive block positions of the recipe.

15. The method of claim 14 in which the step of actuating the controller comprises selecting the recipe on a user interface of the controller.

16. The method of claim 14 in which the step of actuating the controller comprises selecting the recipe on a user interface of the concrete pipe manufacturing machine.

17. The method of claim 14 in which the step of actuating the controller includes:
actuating a locking element to permit motion of the driving blocks before the controller commands the motor to move the driving blocks; and
actuating the locking element again to lock the driving blocks in place in response to a sensor signal indicating that the driving blocks have reached respective positions corresponding to the respective positions prescribed by the recipe.
